(19) United States
(12) Patent Application Publication
(10) Pub. No.: US 2005/0213904 A1
(43) Pub. Date: Sep. 29, 2005

(54) Method and apparatus for processing a preform

(75) Inventors: Jouni Hyvarinen, Helsinki (FI); Pekka Soininen, Helsinki (FI); Anssi Hovinen, Espoo (FI); Heikki Ihalainen, Espoo (FI)

Correspondence Address: OLIFF & BERRIDGE, PLC, P.O. BOX 19928, ALEXANDRIA, VA, 22320, US

(73) Assignee: Nextrom Holding S.A., Morges (CH)

(21) Appl. No.: 10/525,080

(22) PCT Filed: Sep. 1, 2003
(86) PCT No.: PCT/FI03/00637

§ 371 Date: Feb. 18, 2005

(30) Foreign Application Priority Data
Sep. 2, 2002 (FI) 20021564

(51) Int. Cl. G02B 6/04

(52) U.S. Cl. 385/115

(57) ABSTRACT

The present invention relates to a method and an apparatus for processing a preform and/or drawing an optical fiber. The method is characterized by securing the preform (2) to the processing device by means of at least two separate gripping means (4, 6), heating the preform (2) or a section thereof by means of at least one heating device at least locally, generating a tension in the preform (2) by means of the gripping means (4, 6), and processing the preform (2) by moving one of the gripping means (4, 6) and the heating means (12) and keeping the gripping means (4, 6) on the side of the end product of the preform in position relative to the body of the processing device, whereby the end product produced also remains in position relative to the body of the processing device.

### BACKGROUND OF THE INVENTION

The invention relates to a device according to the preamble of claim 1 and to a method according to the preamble of claim 5 for processing a preform to alter its length and diameter, and to a device and method according to claims 16 and 21 for drawing an optical fibre.

In the manufacture of an optical fibre, the blank, i.e. the preform, has to be processed to obtain an outer diameter of the desired size, or to correct any form errors created in the preform, for instance variations in the diameter and errors in the roundness or straightness of the preform.

In the present context, a preform refers to a blank or a part thereof, from which the optical fibre is manufactured. The above parts could include for example rods or tubes and different combinations thereof. The material of the preform could be for instance plastic, glass or another corresponding material. The preform may also include several constituents. Processing a preform can involve stretching or forging at a constant or varying speed, during which the preform may also be rotated at a constant or varying speed around its longitudinal axis.

From hereon, when referring to the stretching, drawing, forging or other processing of a preform, the expression processing will be used, and, in the same way, for the device used for the purpose, the expression processing device, which comprises means for stretching, forging or other deformation of the preform, will be used.

In accordance with the prior art, a preform is processed in a processing device, wherein the preform is heated and subjected to a force in the direction of its longitudinal axis. The processing of a preform is enabled by heating the preform with a heating device, e.g. a heating furnace, to make the preform soften in the heated section. At the same time the processing device creates, tension, e.g. tensile stress, in the preform, whereby the preform stretches in the heated and softened section. As the preform is stretched, its length increases and outer diameter decreases, whereby a stretched preform of the desired thickness is obtained from the processing device. The diameter of the preform obtained in the stretching can be adjusted as desired during the process for a given purpose. In the same way, the preform can also be forged by subjecting it to a compressive force, or its form can be altered in some corresponding manner.

In accordance with the prior art, a preform processing device usually comprises two gripping means for securing the preform to the processing device, and one heating device for heating the preform to enable the processing thereof. The rod-like preform is usually secured at its ends to the gripping means, and during the processing process the preform is subjected to a force by moving at least one of the gripping means in the axial direction of the preform away from or towards the other gripping means. Feeding the preform, tensioned by means of the gripping means, longitudinally through the heating device, enables processing of the preform. Feeding the preform is implemented in accordance with the prior art by moving the preform through the heating device, fixedly installed in the processing device, by means of said two movable gripping means. This is implemented by moving both gripping means in the same direction, allowing the preform to be fed through the fixed, immobile heating device. Another prior art manner of processing a preform is to manufacture a processing device wherein only one of the gripping means is movable relative to the body of the processing device, the other being fixedly installed in the processing device. In accordance with the prior art, the movable gripping means is always at that end of the preform from which the end product is produced as a result of stretching or drawing. Herein, the gripping means at the opposite end of the preform, the feed end, is arranged fixed. To enable processing of the preform, the heating device is arranged movable relative to the body of the processing device, the preform being processed by moving one of the gripping means and the heating device.

In accordance with the prior art, a preform processing device comprises three modules; two gripping means for securing the preform to the processing device, and a heating device for heating the preform or a section thereof, two of which are arranged movable in the above-described manner during the processing process.

Devices of the kind described above, comprising two movable modules, are disclosed in U.S. Pat. No. 6,178,778, for example.

The basic principle in drawing an optical fibre is similar to that in stretching a preform, but the drawing ratios in fibre drawing are considerably higher. The equipment for drawing a fibre also usually comprise two gripping means for securing the preform, from which the fibre is drawn, to a drawer, and at least one heating device for heating the preform to enable drawing of the fibre. Herein, fibre refers to a conventional solid optical fibre, hollow fibre, crystal fibre or another corresponding optical fibre made from plastic, glass or a corresponding production material for optical fibre.

The problem in the described prior art solution comprising two mobile modules is that sufficiently stable conditions, wherein the oscillations of the processing or drawing device are minimized thus eliminating the effect of the oscillations on the quality of the end product, required in the processing, i.e. stretching, forging or another procedure for processing a preform or drawing a fibre, are almost impossible to achieve with the same processing device. This is essentially because in prior art solutions the end product is moved relative to the body of the processing device.

### BRIEF DESCRIPTION OF THE INVENTION

The object of the invention is thus to provide a method and an apparatus implementing the method for solving the above problems and for enabling the modification of the geometry of a preform as desired by reducing the oscillation directed to the end product by holding the end product, produced as the result of stretching or drawing, in position relative to the body of the processing device and by enabling the selection of the drawing or processing direction and easy installation of the preform into the device. The object of the invention is achieved by a method and device that are characterized in what is stated in independent claims 1 and 5, and 16 and 21. Preferred embodiments of the invention are described in the dependent claims.

The object of the invention is achieved with a device for processing/ stretching a preform or with a device for drawing a fibre, the device comprising at least two gripping means for securing the preform to the processing/ stretching device and at least one heating device for heating the preform or a section thereof to the desired temperature in such a way that both the gripping means and the heating device are arranged movable, allowing all of them to be moved optionally by holding the end product produced in the stretching of the preform or the drawing of the fibre in position relative to the body of the processing device. The present invention is based on the device for processing the preform being manufactured such that all its modules, gripping means and heating devices are optionally separately movable. This allows the processing or stretching to be performed in the desired direction relative to the body of the processing device by holding the end product produced in the processing in position relative to the body of the processing device.

It is also preferable in the present invention that each of the gripping means and the heating device is independently movable and that the speed of movement and direction of movement of each of the gripping means and the heating device are separately adjustable. It is also preferable that the gripping means for securing the preform to the processing device also comprise means for rotating the preform around its longitudinal axis during the processing. The processing apparatus of the invention is executable as a vertical or horizontal structure or as a hybrid thereof.

The object of the present invention is achieved by a method of processing a preform, the method utilizing the apparatus of the invention by securing the preform to the processing device by means of at least two separate gripping means, by heating the preform or a section thereof by means of at least one heating device at least locally, by generating a tension in the preform by means of the gripping means, and by processing the preform by feeding it to the heating device by moving one of the gripping means and the heating means in such a manner that the resulting end product is held in position with the second gripping means relative to the body of the processing device.

In the method, the speed of movement and direction of movement of the gripping means and the heating device, and the temperature of the heating device are preferably adjusted in such a manner that the preform is provided with a diameter of substantially the desired size as a result of the processing. It is also preferable that the speed of movement and direction of movement of each gripping means and heating device is adjusted separately. The preform can be rotated around its longitudinal axis during the processing to improve the management of the softened preform and to correct the roundness of the preform.

An advantage of the method and device of the invention is that the position in which the preform is installed and from which it is removed can be selected more freely. At the same time, maintenance work on the apparatus becomes easier. Since the drawing can also be performed using two movements, the third movement remains to be used for other process adjustment measures. When the preform is to be cut after the process, the point of cutting can also be selected more freely in the solution of the invention than in known solutions. In addition, holding the end product generated in the processing in position relative to the body of the processing device ensures the achievement of an end product having the best possible quality.

### BRIEF DESCRIPTION OF THE FIGURES

In the following, preferred embodiments of the invention will be described in detail with reference to the accompanying drawings, in which

FIG. 1a shows the initial situation of the preform processing method according to the present invention, the preform being installed in a processing device according to the present invention for stretching;

FIG. 1b shows a situation in the preform processing method according to the present invention, the preform being stretched with a processing device according to the present invention.

### DETAILED DESCRIPTION OF THE INVENTION

In the following, the present invention will be studied by means of exemplary embodiments. These embodiments only act as examples of the device and method of the present invention, and do not restrict the scope of the invention; on the contrary, the embodiments of the invention may vary within the scope of the claims.

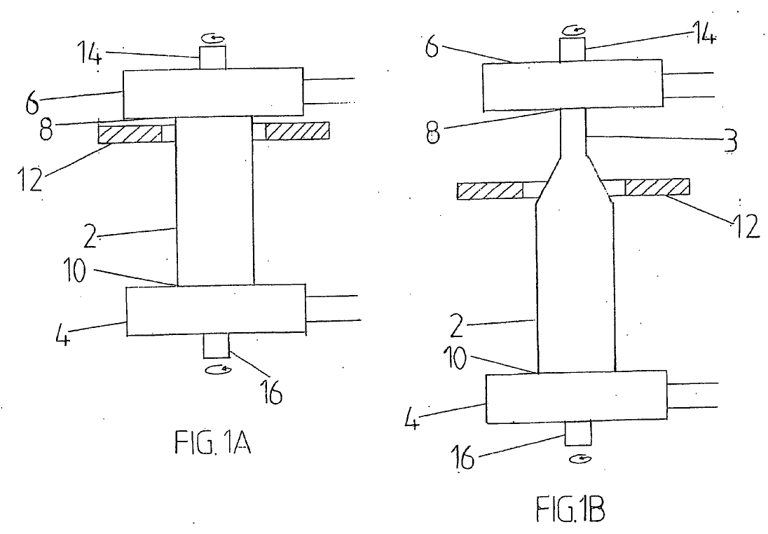

Reference is made to FIG. 1a showing an embodiment of a processing device according to the present invention. In this embodiment, said processing device comprises a first gripping means 4 and a second gripping means 6 for securing a preform to the processing device, a heating device 12 for heating the preform during the processing process, and rotation means 16 and 14 secured to the first and second gripping means 4 and 6, respectively, for rotating the preform around its longitudinal axis. In accordance with FIG. 1a, the elongated preform 2 is installed in the processing device according to an embodiment of the invention, a first end 10 of the preform being secured to the gripping means 4 and a second end 8 to the gripping means 6. FIG. 1a shows the initial situation in the preform processing method of the present invention, the preform being installed in a processing device according to the invention, whose gripping means 4 and 6 and heating device 12 are movable at least in the longitudinal direction of the preform. In this exemplary embodiment, the preform is stretched, but the method and device of the invention can also be used to forge the preform or subject it to other processing procedures.

The device according to the present invention can also be provided with more than two gripping means and/or cutting devices, all of which are movable. In this case, some gripping means are secured between the ends of the preform. The processing device may also comprise several independently movable heating devices 12, allowing the preform to be heated at more than one point at the same time. This allows the stretching or forging to be performed in steps and different heating temperatures to be maintained in the heating devices 12. In addition, this would enable the processing to be started simultaneously at both ends of the preform or at different points of the preform.

In accordance with the present invention, the processing device is configured to enable separate control of each movable module 4, 6 and 12, i.e. each module has independent drives, servo drives, for example. This allows each module 4, 6 and 12 to be moved at different speeds and, if needed, also in different directions, or held in position. The method of the invention for processing a preform utilizes for instance the embodiment of the processing device of the invention of the type described above in FIG. 1 The elongated preform 2 produced by the method is secured to the processing device by means of the gripping means 4 and 6. In the present exemplary embodiment of the method, the initial situation is as shown in FIG. 1a. The preform is first secured, and then subjected to stretching.

In accordance with the present invention, the preform is stretched by utilizing the gripping means 4 and 6, both of which are movable, and the movable heating device 12. In the present embodiment, the stretching of the preform starts at its one end 8, and the stretching of the preform takes place vertically from the top downwards. This means that the heating of the preform by means of the heating device 12 starts at one end 8 of the preform, and at the same time, the preform is subjected to tensile stress by moving the gripping means 4 and 6 relative to each other. In the present embodiment, the lower gripping means 4 is moved downwards in accordance with FIG. 1b , and, as a result of the generated tensile stress, the stretching of the preform 2 starts at the upper end thereof, and the end product produced by the stretching remains in position relative to the body of the stretcher. During the process, the heating device 12 glides downwards.

The preform 2, heated by means of the heating device 12, softens in the section heated, whereby the tensile stress, generated in the preform by means of the gripping means 4 and 6, causes the stretching of the softened section of the preform 2. During the stretching, the diameter of the stretched section 3 of the preform is reduced.

FIG. 1b shows the processing process by showing the relative movements of the movable modules 4, 6 and 12 relative to each other, and the stretching of the preform 2. The rotation means 16 and 14 for rotating the preform during the processing process are secured to the gripping means 4 and 6 to allow them to move with the gripping means.

As the stretching of the preform 2 starts in the initial state in accordance with FIG. 1a , the preform 2 is heated at its upper end with the heating device 12. Once the preform 2 is sufficiently heated, the preform 2 is subjected to tensile stress by moving the lower gripping means 4 downwards in the longitudinal direction of the preform, and by holding the upper gripping means 6 in position. At the same time, the heating device 12 starts to be moved from the upper end 8 of the preform 2 towards the lower end. The tensile stress generated by the movement of the gripping means 4 makes the heated preform stretch, and because the heating point of the preform, i.e. the stretching point, has to continuously move downwards along the preform 2 in the present embodiment, the heating device 12 has to be moved downwards relative to the movement of the lower end 10 of the preform 2.

In the previous exemplary embodiment, a stretched preform 3 is generated from the upper end of the original non-stretched preform 2 as a result of the processing process. The thickness of the generated stretched preform 3, i.e. the stretching ratio of the stretching process, is managed by means of the relative velocities of the movable modules and the temperature of the heating device 12. The preform may also be rotated around its longitudinal axis during the stretching process. Rotating the preform improves the management of the shape of the section thereof that softened as a result of the heating, and the stability of the processing process. In accordance with the invention, the end product generated as a result of the stretching remains in position relative to the body of the processing device, since the upper gripping means 6 are not moved during the stretching.

The above-described exemplary embodiment described stretching a preform, but a similar preform processing method and device, wherein both the gripping means and the heating device are movable, can also be used for forging a preform and in other preform processing processes.

Furthermore, a similar method can be utilized in drawing a fibre. In this case, the gripping means, located at that end of the preform from which fibre is produced, are held in position relative to the body of the drawer. The immobile gripping means constitute or can comprise a spooler apparatus for coiling the produced fibre on a coil. Both gripping devices can also be provided with a coiling apparatus enabling drawing in the desired direction. The optical fibre thus generated is coiled by means of the coiling device, attached to the gripping means, which is immobile relative to the body of the drawer, onto the coil such that both the furnace and the gripping means that moves relative to the body of the drawer move relative to the receiving coiling device for the end product/optical fibre irrespective of the selected drawing direction. In a preferred embodiment of the invention, the processing apparatus is configured to enable vertical stretching of the preform. All modules being movable allows the same apparatus to be used for drawing from both the top downwards and from the bottom upwards, however, preferably from the top downwards, by simultaneously holding the end product generated as a result of the stretching/processing in position relative to the body of the processing device. In addition, the preform can be continuously rotated around its longitudinal axis to adjust the shape of the preform.

In the present invention, the preform can also be secured to the processing device with more than two gripping means, which may all be independently movable or two or more can form a movable group, however, in such a manner that at least two gripping means or groups thereof are independently movable. In addition, there may be several heating devices installed such that one is able to move from the top downwards and the second from the bottom upwards, for example. The heating devices may also move in the same direction in succession, enabling stepwise processing of the preform. The heating devices may move at the same or a different speed.

Such a structure according to the invention enables cutting the preform, implemented with a heat source at a freely selectable point, and, at the same time, the installation and removal of the preform into and from the processing device are facilitated, as all modules are separately controllable during the installation into and removal from the stretcher. Furthermore, stretching from the bottom upwards allows the melt section of the preform to be supported by the rigid, non-stretched section of the preform. This also enables the use of a higher heating temperature.

The above-described technology and device can also be utilized in MCVD, sleeving, and collapsing processes, in drawing and other corresponding optical fibre production processes. Sleeving refers to the increase of the thickness of a solid or tubular preform by melting a tube of the same or a different material onto an existing preform. Collapsing, in turn, refers to the collapsing of a tubular preform into a rod by removing the free space on the inside of the tube by suction such that the inner walls of the tube melt together. The present invention provides the preform stretching process with a new kind of flexibility and reduces the space required by the apparatus.

The present invention is not intended to be restricted to the above embodiments, but the gripping means, the heating devices and their mobility, and the original shape and structure of the preform may vary within the scope of the claims of the invention. It is essential in the invention that, as distinct from the prior art, all modules of the preform stretching apparatus or fibre drawing apparatus are movable, and the stretching/drawing preferably takes place vertically, particularly from the top downwards, by holding the generated end product in position relative to the body of the processing device whereby the gripping means on the side of the end product remains in position relative to the body as the gripping means at the opposite end of the preform and the furnace move.

The processing apparatus according to the invention can be either an independent entity intended only for processing a perform or for drawing a fibre from a preform, or it can be an integrated part of the rest of an apparatus that performs also other actions on the preform or the fibre obtained from it. In addition, the device and the method can be used in shaping a tubular preform to adjust the diameter and to adjust the wall thickness.

It is obvious to a person skilled in the art that as technology advances, the basic idea of the invention can be implemented in a variety of ways. The invention and its embodiments are thus not limited to the above examples, but may vary within the claims.

1. A device for processing/stretching a preform, the device comprising at least two gripping means for securing the preform to the processing device, at least one heating device for heating the preform or a section thereof to a desired temperature, the gripping means and the heating device being arranged movable characterized in that the gripping means and the heating device are arranged optionally movable so that they allow the end product produced to be held in position during the processing process relative to the body of the processing device, irrespective of the direction of the processing/stretching, by holding the gripping means on the side of the end product of the preform in position relative to the body of the processing device.

2. A device as claimed in claim 1, characterized in that the gripping means and the heating device are arranged such that the speed of movement and direction of movement of each of them are separately adjustable.

3. A device as claimed in claim 1, characterized in that it comprises means for rotating the preform around its longitudinal axis during the processing.

4. A device as claimed in claim 1, characterized in that it further comprises one or more independently movable cutting device for cutting the preform and/or a fibre.

5. A method of processing/stretching a preform comprising the steps of:
securing the preform to a processing device by means of at least two separate independently movable gripping means;
heating the preform or a section thereof by means of at least one independently movable heating device at least locally; and
generating a tension in the preform by moving at least one of the gripping means;
characterized in that the method further comprises step of:
processing the preform by feeding it to the heating device by moving one of the gripping means and the heating means and by holding the gripping means on the side of the end product of the preform in position relative to the body of the processing device whereby the end product produced also remains in position relative to the body of the processing device, irrespective of the direction of the processing/stretching.

6. A method as claimed in claim 5, characterized in that the speed of movement and the direction of movement of each gripping means and heating device are separately adjustable.

7. A method as claimed in claim 5, characterized by performing the processing/stretching of the preform vertically from the top downwards.

8. A method as claimed in claim 5, characterized by performing the processing/stretching of the preform vertically from the bottom upwards.

9. A method as claimed in claim 5, characterized by rotating the preform around its longitudinal axis during the processing.

10. A method as claimed in claim 5, characterized by using two or more heating devices in the processing of the preform.

11. A method as claimed in claim 10, characterized by adjusting the speed and direction of movement of each heating device separately.

12. A method as claimed in claim 5, characterized by using the method for correcting variations in the diameter of the preform.

13. A method as claimed in any claim 5, characterized by using the method for correcting the roundness of the preform.

14. A method as claimed in claim 5, characterized by utilizing the method in association with a sleeving process.

15. A method as claimed in claim 5, characterized by utilizing the method in association with a collapsing process.

16. A device for drawing an optical fibre from a preform, the device comprising at least two gripping means, of which at least one is provided with coiling means for the optical fibre, for securing the preform to the drawer, and at least one heating device for heating the preform or a section thereof to a desired temperature, the gripping means and the heating device being are arranged movable characterized in that that gripping means and the heating device are arranged optionally movable such that irrespective of the selected drawing direction, the heating device and one of the gripping means are movable relative to the body of the drawer and to the other gripping means, which is immovable relative to the body of the drawer and to which a coiling device is connected for coiling the end product/optical fibre to a coil, whereby both a heating device and the gripping means that is movable relative to the body of the drawer move relative to the coiling device that receives the end product/optical fibre.

17. A device as claimed in claim 16, characterized in that the gripping means and the heating devices are arranged such that the speed of movement and the direction of movement of each of them are separately adjustable.

18. A device as claimed in claim 16, characterized in that it comprises devices for rotating the preform around its longitudinal axis during the processing.

19. A device as claimed in claim 16, characterized in that coiling means are arranged in each of the gripping means.

20. A device as claimed in claim 16, characterized in that it also comprises one or more independently movable cutting device for cutting the preform and/or the fibre.

21. A method of drawing an optical fibre from a preform comprising the steps of:
securing the preform to a drawer by means of at least two separate independently movable gripping means;
heating the preform or a section thereof by means of at least one independently movable heating device at least locally;
generating a tension in the preform by moving at least one of the gripping means;
characterized in that the method further comprises steps of:
drawing optical fibre from the preform by moving one of the gripping means and the heating device and by holding the gripping means on the side of the produced optical fibre in position relative to the body of the drawer; and
coiling the produced optical fibre with a coiling device arranged in the gripping means that is immobile relative to the body of the drawer onto a coil, whereby both a furnace and the gripping means that is movable relative to the body of the drawer move relative to the coiling device that receives the end product/optical fibre irrespective of the selected drawing direction.

22. A method as claimed in claim 21, characterized in that the speed of movement and the direction of movement of each gripping means and heating device are separately adjustable.

23. A method as claimed in claim 21, characterized by performing the drawing of the optical fibre vertically from the top downwards.

24. A method as claimed in claim 21, characterized by performing the drawing of the optical fibre vertically from the bottom upwards.

25. A method as claimed in claim 21, characterized by rotating the preform around its longitudinal axis during the drawings.

26. A method as claimed in claim 21, characterized by using two or more heating devices in the drawing.

27. A method as claimed in claim 26, characterized by adjusting the speed and direction of movement of each heating device separately.

28. A method as claimed in claim 21, characterized by using the method in shaping a tubular preform for both adjusting the diameter and adjusting the wall thickness.
